(19) United States
(12) Patent Application Publication
(10) Pub. No.: US 2002/0129269 A1
(43) Pub. Date: Sep. 12, 2002

(54) Method and apparatus for inputting secret information

(76) Inventors: Eon Cheol-Shin, Inchon (KR); Young-Gi Kim, Inchon (KR); Eun-Sang Lee, Inchon (KR); Seung-Pyo Eun, Inchon (KR); Baek-Un Kim, Seoul (KR); Hak-Jae Shin, Suwon (KR); Tae-Ho Kim, Seoul (KR); Chae-Ho Cho, Seoul (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/067,633

(22) Filed: Feb. 4, 2002

(30) Foreign Application Priority Data
Jun. 24, 2000 (KR) PCT/KR00/00662
Jun. 3, 2000 (KR) 2000-0030570
Sep. 9, 2000 (KR) PCT/KR00/01036
Aug. 18, 2000 (KR) 2000-0047930

(51) Int. Cl. H04L 9/00

(52) U.S. Cl. 713/200

(57) ABSTRACT

A method for inputting secret information by using and information processing system which comprises means for detecting events and display means, is provided. The method comprises the displaying at least two characters separately on the display means, displaying screen multi-pointers comprising at least tow screen pointers separately on screen of the display means, moving at least two screen pointers on the screen of the display means, and recording information associated with the screen multi-pointers in response to the second event detected by the detecting means.

### RELATED APPLICATIONS

This application is related to U.S. patent application Ser. No. (not assigned), filed concurrently herewith and entitled “METHOD AND APPARATUS FOR INPUTTING SECRET INFORMATION USING MULTIPLE SCREEN POINTERS”, which is hereby incorporated by reference herein.

This application claims for the benefit of earlier filing dates under 35 U.S.C. § 365 (c) of International Application No. PCT/KR00/00662 filed Jun. 24, 2000, designating the United States and claiming for the benefit of the earlier filing date under 35 U.S.C. § 365 (b) of Korean Patent Application No. 2000/0030570 filed Jun. 3, 2000; and International Application No. PCT/KR00/01036 filed Sep. 9, 2000, designating the United States and claiming the benefit of the earlier filing dates under 35 U.S.C. § 365 (b) of Korean Patent Application Nos. 2000/0030570 filed Jun. 3, 2000 and 2000/47930 filed Aug. 18, 2000. International Application No. PCT/KR00/00662 was published in English as WO 01/ 98924 A1 on Dec. 27, 2001, and International Application No. PCT/KR00/01036 was published in English as WO 01/ 99338 A1 on Dec. 27, 2001. This application incorporates by reference International Publications WO 01/ 98924 A1 and WO 01/ 99338 A1.

### BACKGROUND OF THE INVENTION

1. Field of the Invention

The present invention relates to a method and apparatus for inputting secret information, and especially to a method and system for protecting inputted information of a user while the user is inputting secret information into a system even though the inputted information is intercepted or stolen.

2. Discussion of Related Technology

Conventional methods for inputting secret information may include following examples.

First example of the conventional method is to display predetermined symbols corresponding to inputted secret information instead of displaying inputted information themselves. According to the first conventional method, a third person can not recognize inputted information even if he/she sneaks a look into the displayed secret information inputted by a user. Thus, the inputted secret information must be substituted for predetermined symbols that the third person can not recognize. Examples of the predetermined symbols may include a series of “*” or “#” or blanks instead of the secret information inputted by the user.

However, the conventional method has following problems. First, if the third person remembers the keystrokes of the user, the secret information is revealed even though the secret information is not displayed in the form of characters. Further, the third person can reveal the secret information by reading inputted secret information from a memory area of a computer system that the user uses. Or, the inputted secret information may also be revealed by repetitively inputting various possible combinations of key inputs.

Second example of the conventional method is to store or transfer irregularly transformed secret information. According to the second conventional method, a service provider provides a set of random numbers to the user who inputs the secret information, and the user combines the secret information with the random numbers by using a proper transfer function then transfers the transformed secret information.

However, the third person may intercept the set of random numbers and the transfer function used by the user, so that the transformed secret information may be revealed to the third person.

### SUMMARY OF CERTAIN INVENTIVE ASPECTS

The present invention was made to solve the above described problems of the conventional systems or method, and it is an object of the present invention to prevent secret information from being revealed to a third person who sneaks a look at the display of inputted secret information through an input device like a keyboard. Further, the present invention is to prevent secret information from being revealed to a third person who intercepts signals generated by an input device like a keyboard used by a user or performs hacking on a computer system used by a user.

One aspect of the present invention provides a secret information inputting method, using an information processing system which includes an event detecting unit for detecting an event and a display unit, including: displaying at least two of character values on a screen of the display unit, where each of the at least two of character values can be identified from each other; displaying multiple pointers on the screen of the display unit, where the multiple pointers include at least two of pointers, each of which can be identified from each other; moving at least two of pointers out of the multiple pointers on the screen of the display unit in response to a first event detected by the event detecting unit; and recording information on the multiple pointers in response to a second event detected by the event detecting unit.

In the method, said at least two of pointers are respectively identified by at least two of identification signs, each of which can be identified from each other. Said at least two of pointers are formed to be substantially identical in appearance, and each of said at least two of pointers is identified from each other by its display location on said screen of said display unit at a predetermined point of time. Said recording information on said multiple pointers is performed by recording information on a display location of at least one of said multiple pointers on said screen of said display unit. Said recording information on said multiple pointers is performed by recording information on a character value designated by at least one of said multiple pointers on said screen of said display unit. The method may further comprise displaying a reference table for designating at least one of said at least two of pointers; displaying a reference table for designating at least one of said at least two of identification signs; transferring a reference table for designating at least one of said at least two of pointers through a separate communication means; and/or transferring a reference table for designating at least one of said at least two of identification signs through a separate communication means.

Said reference table comprises at least two of identifiers for identifying said at least two of pointers and at least two of index values for referring to said identifiers; said reference table comprises at least two of identifiers for identifying said at least two of pointers and at least two of index values for referring to said identifiers; and/or said reference table comprises at least two of identifiers for identifying said at least two of identification signs and at least two of index values for referring to said identifiers. The method may further comprise retrieving a character value designated by a predetermined pointer of said multiple pointers when said information on said multiple pointers is recorded. Said event detecting unit comprises a first and second input keys; said first event is an operation of receiving a key input from said first input key; and said second event is an operation of receiving a key input from said second input key. Said event detecting unit comprises a displacement detecting unit for detecting a displacement of a predetermined object and an input key; said first event is an operation of said displacement detecting unit detecting a displacement of said predetermined object; and said second event is an operation of receiving a key input from said input key.

Another aspect of the present invention provides a secret information inputting method, using an information processing system which includes an event detecting unit for detecting an event and a display unit, including: displaying at least two of character values on a screen of the display unit, where each of the at least two of character values can be identified from another one(s); changing at least one of character values out of the at least two of character values in response to a first event detected by the event detecting unit; and recording information on the character value(s) in response to a second event detected by the event detecting unit.

The method may further comprise setting at least two of character areas on said screen of said display unit before said step of displaying at least two of character values, wherein said at least two of character areas can be identified from another one(s), and said step of displaying at least two of character values is performed by displaying said at least two of character values on said at least two of character areas, respectively. Each of said at least two of character values is identified by each of identification signs which can be identified from another one(s). Each of said at least two of character areas is identified by each of identification signs which can be identified from another one(s). Said at least one of character values is a figure and said step of changing at least one of character values is performed by increasing said at least one of figures by predetermined amount. Said at least one of character values is a figure and said step of changing at least one of character values is performed by decreasing said at least one of figures by predetermined amount. Said step of changing at least one of character values is performed by changing locations of at least two of character values of said at least one of character values. Said step of changing at least one of character values is performed by changing correspondence relations between said at least two of character areas and said at least two of character values. Said step of changing at least one of character values is performed by changing correspondence relations between said at least two of identification signs and said at least two of character values.

The method may further comprise displaying at least two of identification signs on said screen of said display unit, wherein said step of changing at least one of character values is performed by changing locations of at least two of identification signs of said at least one of identification signs. Said step of recording information on said character value(s) is preformed by recording information on at least one of said character values and a display location of said at least one of said character values on said screen of said display unit. Said step of recording information on said character value(s) is preformed by recording information on at least one of said character values and at least one of character areas where said at least one of said character values is displayed. Said step of recording information on said character value(s) is preformed by recording information on at least one of said character values and an identification sign corresponding to said at least one of said character values.

The method may further comprise displaying a reference table for designating at least one of locations of said at least two of character values on said screen of said display unit; displaying a reference table for designating at least one of said at least two of character areas on said screen of said display unit; displaying a reference table for designating at least one of said at least two of identification signs; transferring a reference table for designating at least one of locations of said at least two of character values through a separate communication means; transferring a reference table for designating at least one of said at least two of character areas through a separate communication means; or transferring a reference table for designating at least one of said at least two of identification signs through a separate communication means. Said reference table comprises at least two of identifiers for identifying locations of said at least two of character values and at least two of index values for referring to said identifiers. Said reference table comprises at least two of identifiers for identifying said at least two of character areas and at least two of index values for referring to said identifiers. Said reference table comprises at least two of identifiers for identifying said at least two of identification signs and at least two of index values for referring to said identifiers. Said reference table comprises at least two of identifiers for identifying said at least two of identification signs and at least two of index values for referring to said identifiers.

The method may further comprise retrieving information on a predetermined character value by using information recorded during said step of recording information on said character value(s) when said information on said character value(s) is recorded. Said event detecting unit comprises a first and second input keys; said first event is an operation of receiving a key input from said first input key; and said second event is an operation of receiving a key input from said second input key. Said event detecting unit comprising a displacement detecting unit for detecting a displacement of a predetermined object and an input key, may further comprise displaying a pointer on said screen of said display unit; and moving said pointer on said screen of said display unit in response to change in displacement of said object detected by said event detecting unit, wherein said first event is an operation of receiving a key input from said input key when said pointer is positioned on a first area of said screen of said display unit; and said second event is an operation of receiving a key input from said input key when said pointer is positioned on a second area of said screen of said display unit. Said event detecting unit is a mouse, a touch screen, or a touch pad.

Another aspect of the present invention provides a secret information inputting device including: an event detecting unit for detecting an event; a display unit; a means for displaying at least two of character values on a screen of the display unit, where each of the at least two of character values can be identified from another one(s); a means for displaying multiple pointers on the screen of the display unit, where the multiple pointers include at least two of pointers, each of which can be identified from another one(s); a means for moving at least two of pointers out of the multiple pointers on the screen of the display unit in response to a first event detected by the event detecting unit; and a means for recording information on the multiple pointers in response to a second event detected by the event detecting unit.

In the device, said at least two of pointers are respectively identified by at least two of identification signs, each of which can be identified from another one(s). Said at least two of pointers are formed to be substantially identical in appearance, and each of said at least two of pointers is identified from another one(s) by its display location on said screen of said display unit at a predetermined point of time. Said means for recording information on said multiple pointers records information on a display location of at least one of said multiple pointers on said screen of said display unit. Said means for recording information on said multiple pointers records information on a character value designated by at least one of said multiple pointers on said screen of said display unit. The device may further comprise means for displaying a reference table for designating at least one of said at least two of pointers; means for displaying a reference table for designating at least one of said at least two of identification signs; means for transferring a reference table for designating at least one of said at least two of pointers through a separate communication means; and/or means for transferring a reference table for designating at least one of said at least two of identification signs through a separate communication means. Said reference table comprises at least two of identifiers for identifying said at least two of pointers and at least two of index values for referring to said identifiers. Said reference table comprises at least two of identifiers for identifying said at least two of pointers and at least two of index values for referring to said identifiers. Said reference table comprises at least two of identifiers for identifying said at least two of identification signs and at least two of index values for referring to said identifiers.

The device may further comprise means for retrieving a character value designated by a predetermined pointer of said multiple pointers when said information on said multiple pointers is recorded. Said event detecting unit comprises a first and second input keys; said first event is an operation of receiving a key input from said first input key; and said second event is an operation of receiving a key input from said second input key. Said event detecting unit comprises a displacement detecting unit for detecting a displacement of a predetermined object and an input key; said first event is an operation of said displacement detecting unit detecting a displacement of said predetermined object; and said second event is an operation of receiving a key input from said input key.

Still another aspect of the present invention provides a secret information inputting device including: an event detecting unit for detecting an event; a display unit; a means for displaying at least two of character values on a screen of the display unit, where each of the at least two of character values can be identified from another one(s); a means for changing at least one of character values out of the at least two of character values in response to a first event detected by the event detecting unit; and a means for recording information on the character value(s) in response to a second event detected by the event detecting unit.

The device may further comprise means for setting at least two of character areas on said screen of said display unit before said step of displaying at least two of character values, wherein said at least two of character areas can be identified from another one(s), and said means for displaying at least two of character values displays said at least two of character values on said at least two of character areas, respectively. In the device, each of said at least two of character values is identified by each of identification signs which can be identified from another one(s). Each of said at least two of character areas is identified by each of identification signs which can be identified from another one(s). Said at least one of character values is a figure and said means for changing at least one of character values increases said at least one of figures by predetermined amount. Said at least one of character values is a figure and said means for changing at least one of character values decreases said at least one of figures by predetermined amount. Said means for changing at least one of character values changes locations of at least two of character values of said at least one of character values. Said means for changing at least one of character values changes correspondence relations between said at least two of character areas and said at least two of character values. Said means for changing at least one of character values changes correspondence relations between said at least two of identification signs and said at least two of character values.

The device may further comprise means for displaying at least two of identification signs on said screen of said display unit, wherein said means for changing at least one of character values changes locations of at least two of identification signs of said at least one of identification signs. Said means for recording information on said character value(s) records information on at least one of said character values and a display location of said at least one of said character values on said screen of said display unit. Said means for recording information on said character value(s) records information on at least one of said character values and at least one of character areas where said at least one of said character values is displayed. Said means for recording information on said character value(s) records information on at least one of said character values and an identification sign corresponding to said at least one of said character values. The device may further comprise means for displaying a reference table for designating at least one of locations of said at least two of character values on said screen of said display unit; means for displaying a reference table for designating at least one of said at least two of character areas on said screen of said display unit; means for displaying a reference table for designating at least one of said at least two of identification signs; means for transferring a reference table for designating at least one of locations of said at least two of character values through a separate communication means; means for transferring a reference table for designating at least one of said at least two of character areas through a separate communication means; and/or means for transferring a reference table for designating at least one of said at least two of identification signs through a separate communication means.

In the device, the reference table comprises at least two of identifiers for identifying locations of said at least two of character values and at least two of index values for referring to said identifiers. Said reference table comprises at least two of identifiers for identifying said at least two of character areas and at least two of index values for referring to said identifiers. Said reference table comprises at least two of identifiers for identifying said at least two of identification signs and at least two of index values for referring to said identifiers. Said reference table comprises at least two of identifiers for identifying said at least two of identification signs and at least two of index values for referring to said identifiers. The device further comprises means for retrieving information on a predetermined character value by using information recorded during said step of recording information on said character value(s) when said information on said character value(s) is recorded. In the device, said event detecting unit comprises a first and second input keys; said first event is an operation of receiving a key input from said first input key; and said second event is an operation of receiving a key input from said second input key. Said event detecting unit comprises a displacement detecting unit for detecting a displacement of a predetermined object and an input key, and may further comprise: a means for displaying a pointer on said screen of said display unit; and a means for moving said pointer on said screen of said display unit in response to change in displacement of said object detected by said event detecting unit, wherein said first event is an operation of receiving a key input from said input key when said pointer is positioned on a first area of said screen of said display unit; and said second event is an operation of receiving a key input from said input key when said pointer is positioned on a second area of said screen of said display unit. Said event detecting unit is a mouse, a touch screen, or a touch pad.

A further aspect of the present invention provides a recording medium having a secret information inputting program, using an information processing system which comprises an event detecting unit for detecting an event and a display unit. The program includes the features of a secret information inputting method comprising displaying at least two of character values on a screen of the display unit, where each of the at least two of character values can be distinguished from each other; displaying multiple pointers on the screen of the display unit, where the multiple pointers include at least two of pointers, each of which can be distinguished from each other; moving at least two of pointers out of the multiple pointers on the screen of the display unit in response to a first event detected by the event detecting unit; and recording information on the multiple pointers in response to a second event detected by the event detecting unit.

In the method, said at least two of pointers are respectively identified by at least two of identification signs, each of which can be distinguished from each other. Said at least two of pointers are formed to be substantially identical in appearance, and each of said at least two of pointers is distinguished from each other by its display location on said screen of said display unit at a predetermined point of time. Said recording information on said multiple pointers is performed by recording information on a display location of at least one of said multiple pointers on said screen of said display unit. Said recording information on said multiple pointers is performed by recording information on a character value designated by at least one of said multiple pointers on said screen of said display unit. The method may further comprise displaying a reference table for designating at least one of said at least two of pointers; displaying a reference table for designating at least one of said at least two of identification signs; transferring a reference table for designating at least one of said at least two of pointers through a separate communication means; and/or transferring a reference table for designating at least one of said at least two of identification signs through a separate communication means.

Said reference table comprises at least two of identifiers for identifying said at least two of pointers and at least two of index values for referring to said identifiers; said reference table comprises at least two of identifiers for identifying said at least two of pointers and at least two of index values for referring to said identifiers; and/or said reference table comprises at least two of identifiers for identifying said at least two of identification signs and at least two of index values for referring to said identifiers. The method may further comprise retrieving a character value designated by a predetermined pointer of said multiple pointers when said information on said multiple pointers is recorded. Said event detecting unit comprises a first and second input keys; said first event is an operation of receiving a key input from said first input key; and said second event is an operation of receiving a key input from said second input key. Said event detecting unit comprises a displacement detecting unit for detecting a displacement of a predetermined object and an input key; said first event is an operation of said displacement detecting unit detecting a displacement of said predetermined object; and said second event is an operation of receiving a key input from said input key.

A still further aspect of the present invention provides a recording medium having a secret information inputting program, using an information processing system which comprises an event detecting unit for detecting an event and a display unit. The program includes the features of a secret information inputting method comprising: displaying at least two of character values on a screen of the display unit, where each of the at least two of character values can be distinguished from one another; changing at least one of character values out of the at least two of character values in response to a first event detected by the event detecting unit; and recording information on the character value(s) in response to a second event detected by the event detecting unit.

The method may further comprise setting at least two of character areas on said screen of said display unit before said step of displaying at least two of character values, wherein said at least two of character areas can be distinguished from one another, and said step of displaying at least two of character values is performed by displaying said at least two of character values on said at least two of character areas, respectively. Each of said at least two of character values is identified by each of identification signs which can be distinguished from one another. Each of said at least two of character areas is identified by each of identification signs which can be distinguished from one another. Said at least one of character values is a figure and said step of changing at least one of character values is performed by increasing said at least one of figures by predetermined amount. Said at least one of character values is a figure and said step of changing at least one of character values is performed by decreasing said at least one of figures by predetermined amount. Said step of changing at least one of character values is performed by changing locations of at least two of character values of said at least one of character values. Said step of changing at least one of character values is performed by changing correspondence relations between said at least two of character areas and said at least two of character values. Said step of changing at least one of character values is performed by changing correspondence relations between said at least two of identification signs and said at least two of character values.

The method may further comprise displaying at least two of identification signs on said screen of said display unit, wherein said step of changing at least one of character values is performed by changing locations of at least two of identification signs of said at least one of identification signs. Said step of recording information on said character value(s) is preformed by recording information on at least one of said character values and a display location of said at least one of said character values on said screen of said display unit. Said step of recording information on said character value(s) is preformed by recording information on at least one of said character values and at least one of character areas where said at least one of said character values is displayed. Said step of recording information on said character value(s) is preformed by recording information on at least one of said character values and an identification sign corresponding to said at least one of said character values.

The method may further comprise displaying a reference table for designating at least one of locations of said at least two of character values on said screen of said display unit; displaying a reference table for designating at least one of said at least two of character areas on said screen of said display unit; displaying a reference table for designating at least one of said at least two of identification signs; transferring a reference table for designating at least one of locations of said at least two of character values through a separate communication means; transferring a reference table for designating at least one of said at least two of character areas through a separate communication means; or transferring a reference table for designating at least one of said at least two of identification signs through a separate communication means. Said reference table comprises at least two of identifiers for identifying locations of said at least two of character values and at least two of index values for referring to said identifiers. Said reference table comprises at least two of identifiers for identifying said at least two of character areas and at least two of index values for referring to said identifiers. Said reference table comprises at least two of identifiers for identifying said at least two of identification signs and at least two of index values for referring to said identifiers. Said reference table comprises at least two of identifiers for identifying said at least two of identification signs and at least two of index values for referring to said identifiers.

The method may further comprise retrieving information on a predetermined character value by using information recorded during said step of recording information on said character value(s) when said information on said character value(s) is recorded. Said event detecting unit comprises a first and second input keys; said first event is an operation of receiving a key input from said first input key; and said second event is an operation of receiving a key input from said second input key. Said event detecting unit comprising a displacement detecting unit for detecting a displacement of a predetermined object and an input key, may further comprise displaying a pointer on said screen of said display unit; and moving said pointer on said screen of said display unit in response to change in displacement of said object detected by said event detecting unit, wherein said first event is an operation of receiving a key input from said input key when said pointer is positioned on a first area of said screen of said display unit; and said second event is an operation of receiving a key input from said input key when said pointer is positioned on a second area of said screen of said display unit. Said event detecting unit is a mouse, a touch screen, or a touch pad.

### BRIEF DESCRIPTION OF THE DRAWINGS

FIG. 1 is a schematic block diagram of an embodiment of a information processing system for a secret information inputting method according to the present invention.

FIG. 2 is a flow chart of an embodiment of a secret information inputting method according to the present invention.

FIG. 3 is an embodiment of an input window for embodying a secret information inputting method according to the present invention.

FIG. 4 is an embodiment of an identification sign reference table for embodying a secret information inputting method according to the present invention.

FIG. 5 is an exemplary display of character area, character value and identification sign according to a secret information inputting method of the present invention.

FIG. 6 is another exemplary display of character area, character value and identification sign according to a secret information inputting method of the present invention.

FIG. 7 is an exemplary display of character area, character value and identification sign after values of figures in character area in FIG. 6 are increased.

FIG. 8 is an example of a display screen for embodying a secret information inputting method according to the present invention.

### DETAILED DESCRIPTION OF CERTAIN INVENTIVE EMBODIMENT

Preferred embodiments and operations thereof will be described in detail with reference to the accompanying drawing.

Information Processing System

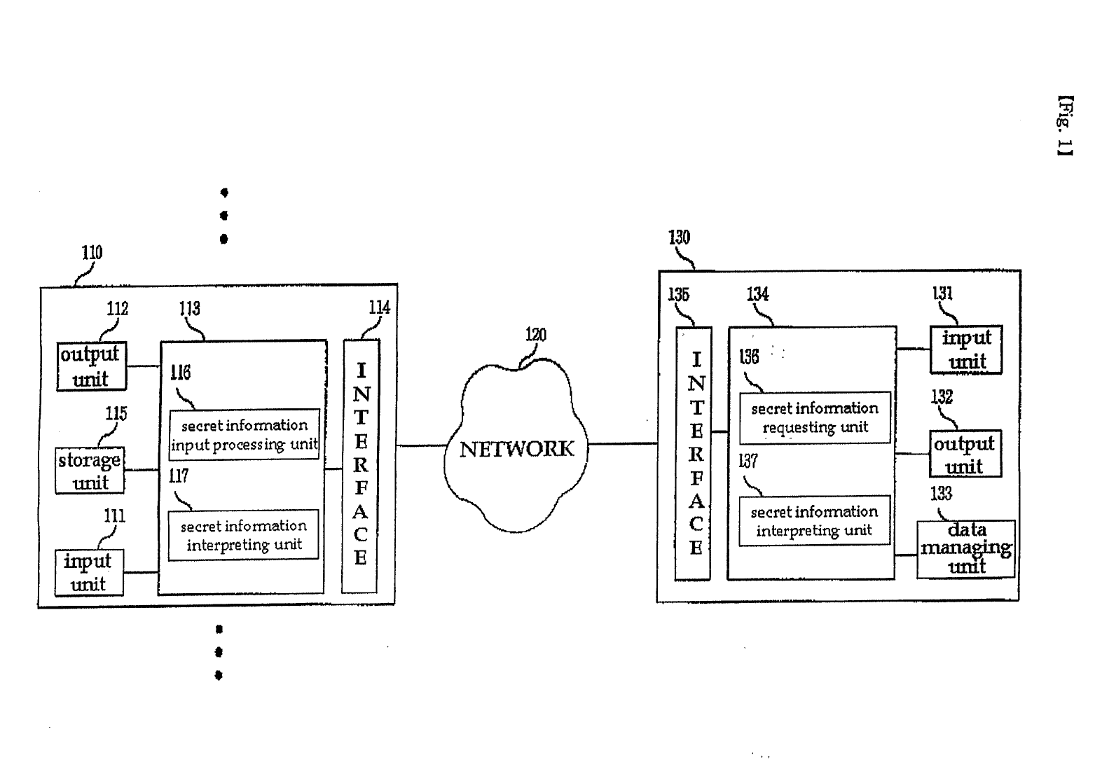

FIG. 1 is a schematic block diagram of an embodiment of a information processing system for embodying a secret information inputting method according to the present invention.

As shown in FIG. 1, the information processing system according to the present invention includes a user-side terminal device 110, a server system 130 and a network 120 for connecting the user terminal device 110 and the server system 130. The network 120 may include Internet or Intranet, or wired or wireless network. The information processing system of the present invention may be embodied as a stand-alone type system where the terminal device 110 is not connected to the server system 130.

The user-side terminal device 110 includes an input unit 111 for inputting information, an output unit 112 for outputting information, an interface 114 for networking, a information processing unit 113 for processing information which is inputted from the input unit 111, transferred from networks through the interface 114 or will be transferred to the output unit 112 and a storage unit 115 for storing various information.

The output unit 112 may preferably be a display device having a display screen. The output unit 112 presents character values referred during inputting secret information and identification signs for identifying the character values, or shows index information of identification signs received from the server system 130. The display device may preferably be selected conventional displays used together with computer systems for visually displaying information to users. For example, CRT display, LCD display or a beam projector may be used as the display device.

The input unit 111 receives secret information from the user. The input unit 111 may include an event detecting unit for detecting various events generated by the user. The event detecting unit may be embodied according to the type of generated events. For example, in case the generated event is keystrokes, a keyboard may be used as the event detecting unit. Or, in case the generated event is the user's action or movement, a mouse, a touch pad or a pointing stick may be used as the event detecting unit for detecting the action or movement of the user. Or, in case the generated event is clicking a mouse button, the mouse can be the event detecting unit.

The output unit 112 and input unit 111 may be formed in a frame. A touch screen is the example of this embodiment, where the user may watch the screen of the output unit 112 and select character values on the screen by using a finger or a stick.

The output unit 112 presents at least two of character values and at least two of identification signs for identifying the at least two of character values on the display device when the user inputs secret information. The user finds out real identification signs used for inputting secret information out of the various identification signs by referring to the identification sign reference table provided by the server system 130. In other words, the service provider provides identification sign reference table used for selecting identification signs which identify real character values, and the user can select real character values by referring to the identification sign reference table.

The information processing unit 113 orders to display a plurality of character values and identification signs on the display device, processes events detected by the event detecting unit and generated by the user, changes character values in response to the events and stores character values identified by the selected identification signs on the storage device. The information processing unit 113 performs operations in response to a secret information request from the server or interpretation of the secret information inputted by the user. The information processing unit 113 may include a secret information input processing unit 116 for processing secret information inputted by the user and a secret information interpreting unit 117 for interpreting the secret information inputted by the user.

The server system 130 may include an input unit 131, an interface 135 for connecting with a network, an information processing unit 134 for retrieving information out of user information transferred from the network through the interface 135, a data managing unit 133 for storing information on users and a identification sign reference table shared with a corresponding user and an output unit 132 for outputting processed result.

The secret information processing unit 134 of the server system 130 may include a secret information requesting unit 136 for requesting the user-side terminal device 110 to input secret information and a secret information interpreting unit 137 for interpreting information transferred from the user.

The secret information requesting unit 136 manages the identification sign reference table which is provided to the user, provides the identification sign reference table and receives secret information from the user. The secret information requesting unit 136 requests the user for the secret information when the user wants to connect to the server system 130, and provides to the user-side terminal device 110 as many or less identification sign reference tables as or than the number of secret characters included in the secret information. It is preferable that the index values, which are used for selecting real character values, of the identification sign reference tables are shared between the operator and the user in advance.

The secret information interpreting unit 137 may comprised of an interpreting module for interpreting secret information out of information from the user. Real secret information is retrieved out of information provided from the user by using the identification sign reference table transferred when the secret information is inputted.

First Embodiment

Now, embodiments of the present invention are described in detail.

First, the user-side terminal device displays N different character values on the display device of the output unit 112. According to an embodiment of the present invention, the N character values are displayed in a form of characters, figures, symbols or diagrams on a predetermined location of the screen.

According to an embodiment of the present invention, a process for setting N character areas on the screen is performed before the character values are displayed on the screen. Then, the character values are displayed on the character areas. The N character values can be distinguished by each of the character areas by displaying each of the N character values on each of the N character areas, where each of the displayed character values is not superposed on other ones.

According to another embodiment of the present invention, it is also possible to display N character values, each of which is not superposed on other ones without setting character areas on the screen. In this case, each of the N character values can be distinguished by the unique location of each of the character values on the screen. Or, for example, it is also possible to distinguish each of the character values by various information, such as color, size, shape of a character area, etc., which identifies each of the N character values.

According to another embodiment of the present invention, the N character values displayed on the screen may be distinguished by N identification signs, respectively. In this case, the N identification signs are preferably displayed on respective positions of the screen corresponding to the N character values. It also is preferable to display the identification signs in the form of characters, figures, symbols or diagrams on predetermined positions of the screen.

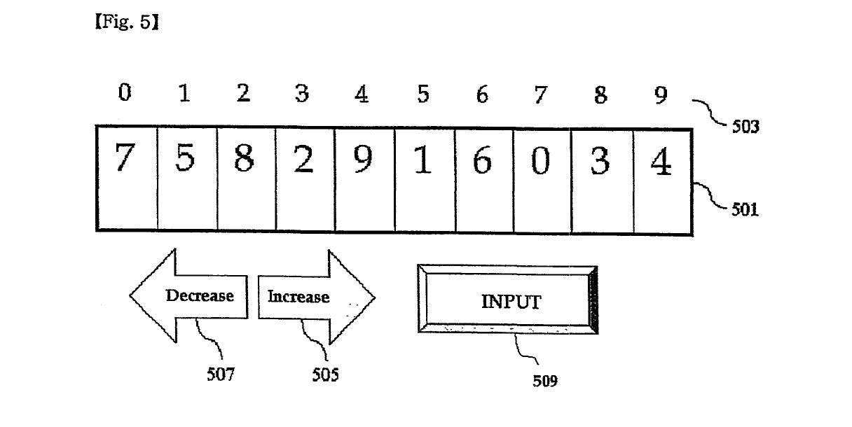

According to another embodiment of the present invention, first N character areas are set on the screen, and N character values are respectively displayed on the N character areas so as not to be superposed on other ones. Then, the N character areas are distinguished by N identification signs. FIG. 5 shows character areas, identification signs and character values displayed on the screen according to this embodiment. According to the embodiment shown in FIG. 5, ten (10) character areas 501 and ten (10) identification signs 503 are displayed on the display device. On the ten (10) character areas, ten (10) character values, i.e. zero (0) to nine (9), are displayed so as not to be superposed on other ones. According to the embodiment shown in FIG. 5, the ten (10) character areas are in the form of ten (10) adjacent boxes, where ten (10) figures are respectively displayed. The ten (10) identification signs 503 are sequentially disposed near the character areas 501, so that each of the identification signs 503 identifies each of the character areas 501.

Then, the user selects desired character value(s) out of the N character values in order to input secret information. According to this embodiment, it is premised that, for example, the secret information is composed of k characters. Further, each of the k characters which composes the secret information is defined as a “secret character” in this specification.

According to another embodiment of the present invention, the N character values are respectively identified by positions of the N character values on the display, and in this case, the user may select desired position(s) of the character value(s) used for inputting secret information. In case the N character values are respectively identified by the N identification signs, the user may select desired identification sign(s) which identifies (identify) character value(s) used for inputting secret information. In case the N character values are displayed on the N character areas, the user may select desired character area(s), where character value(s) used for inputting secret information is (are) displayed. Or, in case N character areas are respectively identified by the N identification signs, the user may select desired identification sign(s), which identifies (identify) character area(s) where the character value(s) used for inputting secret information is (are) displayed.

The user may select character value(s), character area(s) or identification sign(s) for inputting secret information, as described above, but the user may also retrieve (an) identification sign(s) predetermined by the server and the user. This embodiment will be described later.

In case the selected character values, those displayed on the selected character areas, those referred to by the selected identification signs or those displayed on character areas referred to by the selected identification signs are not the same with the secret characters that the user wants to input, it is required for the user to change the character values. In order to meet this requirement, the user generates a first event and the event detecting unit detects the first event generated by the user.

Examples of the first event generated by the user in order to change the displayed character values may include, for example, a keystroke of a predetermined key of the keyboard, movement of the mouse, clicking a mouse button, etc. According to the embodiment shown in FIG. 5, the first event may be a keystroke of a key, i.e. up-arrow key or down-arrow key, of the keyboard. Or, the first event may be pushing a predetermined key of the keyboard or clicking a mouse button after moving a pointer on a “Increase” display area 505 or “Decrease” display area 507 on the screen.

Then, the event detecting unit detects the first event generated by the user, and, in response to this, the information processing system changes the character values. Examples of the method for changing the character values may include increasing or decreasing the character values by a predetermined value in case the character values are figures. Or, in case the character values are character sets, it is possible to change the correspondence relation between the identification signs and the character values or between the character areas and the character values.

According to an embodiment of the present invention, the character values displayed on the screen are figures, and the change of the character values are performed by increasing or decreasing values of the figures. According to the embodiment shown in FIG. 5, in case the first event is the keystroke of up-arrow key or clicking the mouse button when the pointer is positioned on the “Increase” display area 505, the character values, or the figures, displayed on the character areas 501 are increased by one (1). Or, in case the first event is the keystroke of down-arrow key or clicking the mouse button when the pointer is positioned on the “Decrease” display area 507, the character values, or the figures, displayed on the character areas 501 are decreased by one (1). According to another embodiment of the present invention, change of the character values may be performed by first increasing or decreasing codes readable by a computer system, such as ASCII codes, and then changing character values corresponding to the increased or decreased codes.

According to the embodiment where character areas are set and character values are displayed on the character areas, it is possible to change the character values by changing the correspondence relation between the character areas and the character values displayed on the character areas. According to the embodiment where the character areas or the character values are identified by identification signs, it is possible to change the character values by changing the correspondence relation between the character areas and the identification values or between the character values and the identification values.

For example, dispositions of two or more of the character values displayed on the character areas may be rearranged. According to the example shown in FIG. 5, in case the first event is the keystroke of the up-arrow key or clicking a mouse button when the pointer is positioned on the “Increase” display area 505, each of the characters displayed on the character area 501 is moved rightward to the next character area. In case the first event is the keystroke of the down-arrow key or clicking a mouse button when the pointer is positioned on the “Decrease” display area 507, each of the characters displayed on the character area 501 is moved leftward to the next character area.

As an example of a method for changing the correspondence relation between character areas and the character values, between identification signs and character values or between identification signs and character areas, it is possible to simply change the correspondence relation itself instead of rearrangement of the identification signs, character areas or character values. This kind of correspondence relation can be displayed by, for example, solid lines in order for the user to recognize the relations explicitly.

The process for changing the character values may be repeatedly performed until desired character values are displayed, where the desired character values may be displayed on the character areas, designated by the identification signs or displayed on the character areas which are designated by the identification signs. Of course, this process for changing the character values may not be performed if the desired character values are displayed from the beginning.

After the desired secret information coincides with the selected character values, character values designated by the selected identification signs, character values displayed on selected character areas or character values displayed on character areas which are designated by the selected identification signs, the user inputs those character values to the information processing system as secret information. This process of inputting character values may be performed in accordance with an operation for generating a second event. Examples of the second event may include a keystroke of a predetermined key of the keyboard, moving the mouse and clicking a mouse button. According to the embodiment shown in FIG. 5, the second event may be a keystroke of a predetermined key, like “Enter” key, of the keyboard. Or, the user may move the mouse to locate the pointer on “Input” display area 509 and click the mouse button or press a predetermined key of the keyboard, and this operation can be an example of the second event.

The detecting unit detects the second event and, in response to this, the information processing system records on the storage device the selected character values, character values corresponding to the selected identification signs or the information on the character values corresponding to the selected character areas. Information recorded on the storage device may include the corresponding character values, character areas, change history of identification sings and/or finally selected character values, themselves.

Second Embodiment

Now, the second embodiment for the secret information input method of the present invention is described in detail.

First, the user-side terminal device displays N different character values on the display device of the output unit 112. According to an embodiment of the present invention, the N character values are displayed in a form of characters, figures, symbols or diagrams on a predetermined location of the screen.

According to an embodiment of the present invention, a process for setting N character areas on the screen is performed before the character values are displayed on the screen. Then, the character values are displayed on the character areas. The N character values can be distinguished by each of the character areas by displaying each of the N character values on each of the N character areas, where each of the displayed character values is not superposed on other ones.

According to another embodiment of the present invention, it is also possible to display N character values each of which is not superposed on other ones without setting character areas on the screen. In this case, each of the N character values can be distinguished by the unique location of each of the character values on the screen. Or, for example, it is also possible to distinguish each of the character values by various information, such as color, size, shape of a character area, etc., which identifies each of the N character values.

Then, the user-side terminal device displays M uniquely identifiable pointers on the screen of the output unit 112. The M pointers have same forms and are called as “multiple pointers” in this specification. According to an embodiment of the present invention, each of the M pointers may be in the form of an arrow. Or, each of the M pointers may be in the form of a character, a figure, a symbol or a diagram.

According to another embodiment of the present invention, it is also possible to display M pointers, each of which is not superposed on other ones. In this case, each of the M pointers can be distinguished by the unique location of each of the pointers on the screen at a specific time. Or, for example, it is also possible to distinguish each of the M pointers by various information, such as color, size, shape, etc., which identifies each of the M pointers.

According to another embodiment of the present invention, the M pointers may be distinguished by M identification signs, respectively. In this case, the M identification signs are preferably displayed on respective positions of the screen corresponding to the M pointers. It also is preferable to display the identification signs in the form of characters, figures, symbols or diagrams on predetermined positions of the screen.

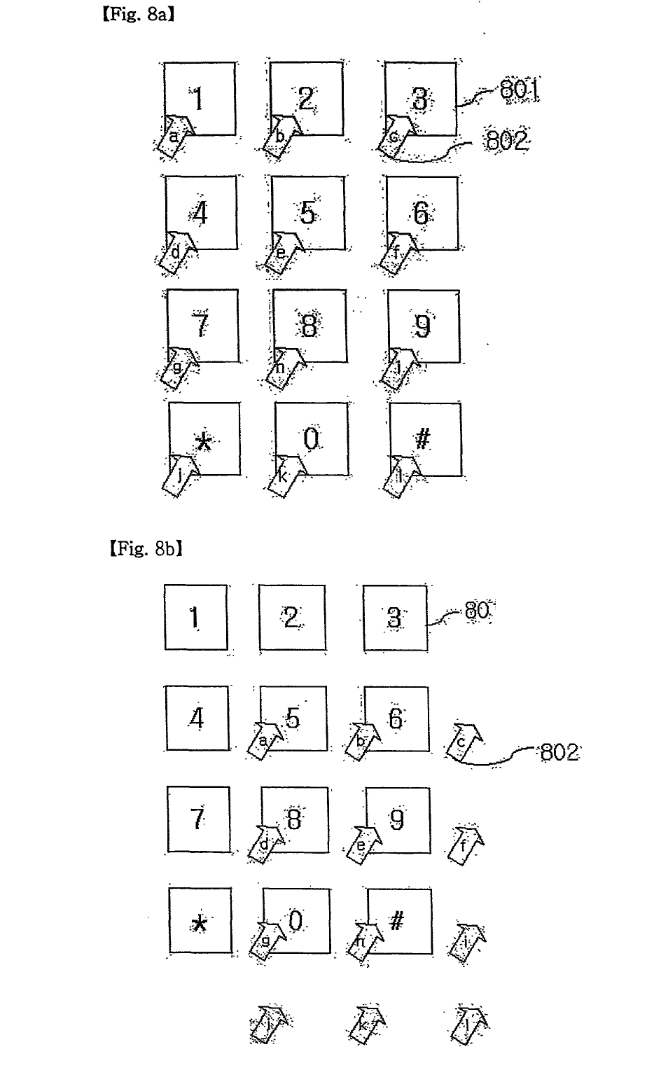

FIG. 8 shows N character values and M pointers displayed on the screen according to this embodiment. According to the embodiment shown in FIG. 8, numbers of displayed character values, N, and pointers, M, are commonly twelve (12). As shown in FIG. 8, twelve (12) character values, i.e. zero (0) to nine (9), “*(asterisk)” and “#(sharp)”, are respectively displayed on twelve (12) character areas, and twelve (12) pointers 802 of arrow shapes are displayed respectively corresponding to the twelve (12) character areas. The twelve (12) pointers can be distinguished by twelve (12) identification signs, i.e. “a” to “l”. The twelve (12) identification signs are respectively displayed in the arrow-shaped pointers, as shown in FIG. 8.

The user selects desired pointer(s), which is (are) used for inputting secret information, out of the M pointers.

According to the embodiment where the M pointers are distinguished by their locations, the user may select desired location(s) of the pointer(s) used for inputting secret information. In case the M pointers are distinguished by M identification signs, the user may select desired identification sign(s) which identifies (identify) pointer(s) used for inputting secret information.

The user may select character value(s), character area(s) or identification sign(s) for inputting secret information, as described above, but the user may also retrieve (an) identification sign(s) predetermined by the server and the user. This embodiment will be described later.

The user moves the multiple pointers on the screen, selects desired character(s) by using selected pointer(s) and inputs the selected characters into information processing system in order to input secret information.

In case the character values designated by the pointers or those displayed on the character areas are not the same with the secret characters that the user wants to input, it is required for the user to change display locations of the multiple pointers. In order to meet this requirement, the user generates a first event and the event detecting unit detects the first event generated by the user. Examples of the first event generated by the user in order to change the locations of the multiple pointers displayed on the screen may include, for example, a keystroke of a predetermined key of the keyboard, movement of the mouse, clicking a mouse button, etc.

The information processing system changes display locations of the pointers on the screen in response to the first event detected by the event detecting unit.

After the desired secret information coincides with the character values designated by the selected pointers out of the multiple pointers or those displayed on character areas designated by the selected pointers by changing display locations of the multiple pointers, the user inputs those character values to the information processing system as secret information. This process of inputting character values may be performed in accordance with an operation for generating a second event. Examples of the second event may include a keystroke of a predetermined key of the keyboard, moving the mouse and clicking a mouse button. According to an embodiment of the present invention, the second event may be a keystroke of a predetermined key, like “Enter” key, of the keyboard.

The event detecting unit detects the second event generated by the user, and, in response to this, the information processing system records on the storage device information on the character values designated by the selected pointers. Information recorded on the storage device may include locations of the multiple pointers including selected pointers or change history of multiple pointers. Or, Character values designated by the finally selected pointers may be included in the information on the character values.

According to the embodiment shown in FIG. 8a, in case the pointer to be used for inputting secret information is that designated by the identification sign, e.g. “e” and the desired secret character is “nine (9)”, the pointer designated by the identification sign “e” does not point at the character “nine (9)”, as shown in the drawing. Thus, the user generates a first event for moving the whole multiple pointers. The information processing system of the present invention moves the whole multiple pointers on the screen in response to the first event detected by the event detecting unit. The user repeatedly generates the first event until the pointer designated by the identification sign “e” points at the secret character “nine (9)”. FIG. 8(b) shows the pointer designated by the identification sign “e” of the multiple pointers now pointing at the secret character “nine (9)” after the multiple pointers have moved by a predetermined displacement. As shown in FIG. 8b, after the pointer designated by the identification sign “e” of the multiple pointers points at the secret character “nine (9)”, the user generates a second event and the information processing system records information on the multiple pointers at this moment. The process for inputting secret information, for example “nine (9)”, is completed.

This process for inputting secret information is repeatedly performed unit all of the k secret characters composing the secret information are inputted.

It is possible for an interpreter to retrieve the secret information, which the user wants to input, by using the recorded information and the reference table information shared with the user. For example, if the recorded information on the character values is information on locations of the multiple pointers on the screen, the interpreter can find that the secret character inputted by the user is character “nine (9)” which is pointed by the pointer designated by the identification sign “e” by using the information on locations of the multiple pointers on the screen and the identification sign, i.e. “e”, selected by the user.

Indexing of the Identification Signs

Now, according to an embodiment of the present invention, a process for selecting a character value used for inputting a secret character out of N character values (in case of the first embodiment) or M pointers (in case of the second embodiment) displayed on the screen, is described in detail.

In this specification, a true character value used for inputting a secret character or information for identifying a pointer out of the multiple pointers is defined to be a “identifier information”.

The identifier information is preferably shared between the system and the user in an encrypted form. In case of the first embodiment, this identifier information may be a character value itself, a character area where a character value is displayed, an identification sign for identifying a character value or an identification sign for identifying a character area where a character value is displayed. In case of the second embodiment, the identifier information may be an identification sign for identifying a specific pointer out of the multiple pointers.

As a method for encrypting this identifier information, It is possible to use an “indexing table method” where an indexing table is used for encrypting. The indexing table method of the present invention means that the user and interpreter share an identifier reference table which is referred to by the user or the interpreter when secret information is inputted or interpreted, where an identifier of the identifier reference table is designated for inputting the secret information.

The identifier reference table may be transferred between the user and the interpreter through a communication unit, such as a mobile phone, a pager, a telephone, a facsimile, etc. The identifier reference table may be generated by using random number generators provided to the user and interpreter. It must be appreciated by an ordinary skilled person in the art that every and any method for sharing the identifier reference table between the user and interpreter is included in the scope of the present invention.

The method using identifier reference table is described in more detail as an example of the indexing table method. According to this method, the identifier reference table may include lists of identifiers used for inputting a secret character and index values respectively corresponding to the identifiers, where each of the identifiers may represent a character value, a character area or an identification sign, and each of the index values may be used for referring to a corresponding identifier. In case of the second embodiment of the present invention, the identifier reference table may include lists of identifiers used for inputting a secret character and index values respectively corresponding to the identifiers, where each of the identifiers may represent a pointer of the multiple pointers or an identification sign for identifying a pointer, and each of the index values may be used for referring to a corresponding identifier. The system and the user share the index values for selecting a character value, a character area or an identification sign or for selecting a pointer or an identification sign. Then, an identifier is selected by an index value, and a secret character is inputted by using the selected identifier, i.e. character value, character area or identification sign.

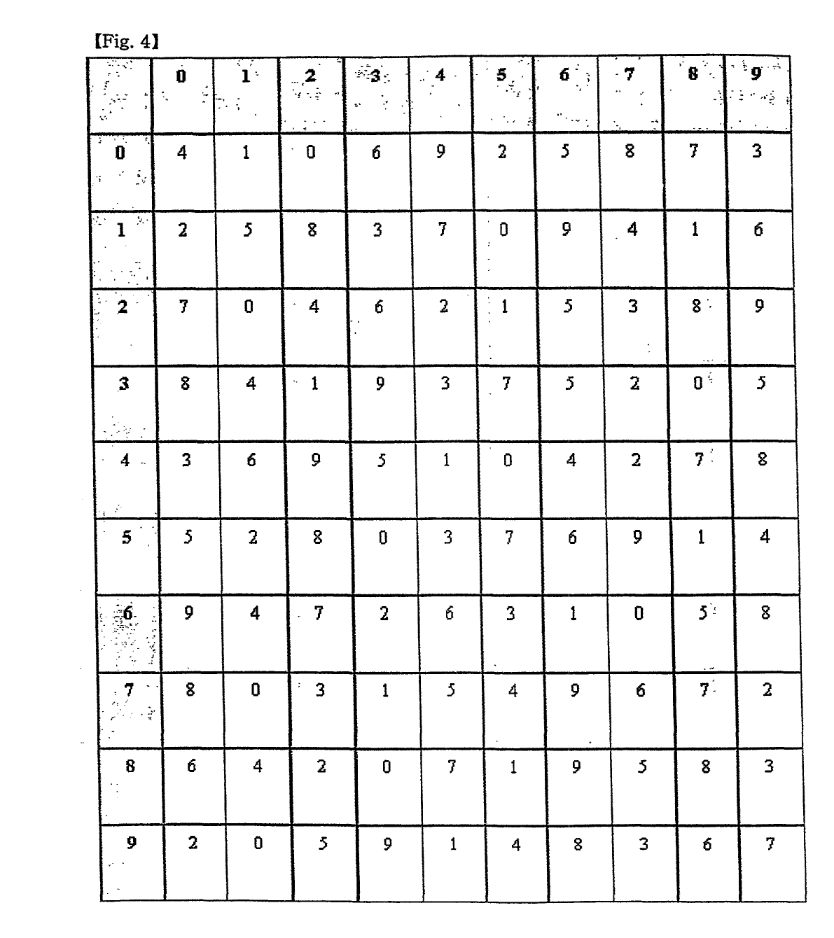

According to an embodiment of the present invention, the identifier reference table as shown in FIG. 4 is used. Referring to FIG. 4, the identifier reference table has ten (10) rows and ten (10) columns. As shown in FIG. 4, the first row and first column of the identifier reference table have index values, and other rows or columns have identifiers, i.e. character values, character areas or identification signs for them or pointers. According to an exemplary embodiment of the present invention where secret information is composed of four (4) figures, an identification sign, located at a position defined by the row and column respectively designated by the first and second figures of the secret information, is selected as that used for inputting a secret character.

According to the above described method, instead of a character information, a character area information or an identification sign information for identifying a character value used for inputting secret information, or instead of an identification sign information used for inputting secret information, the service provider provides an index value of them to the user for inputting secret information. Therefore, information on real character value, character area or identification sign, or a pointer or identification sign for identifying a pointer is not revealed to a third person.

Server and Client System

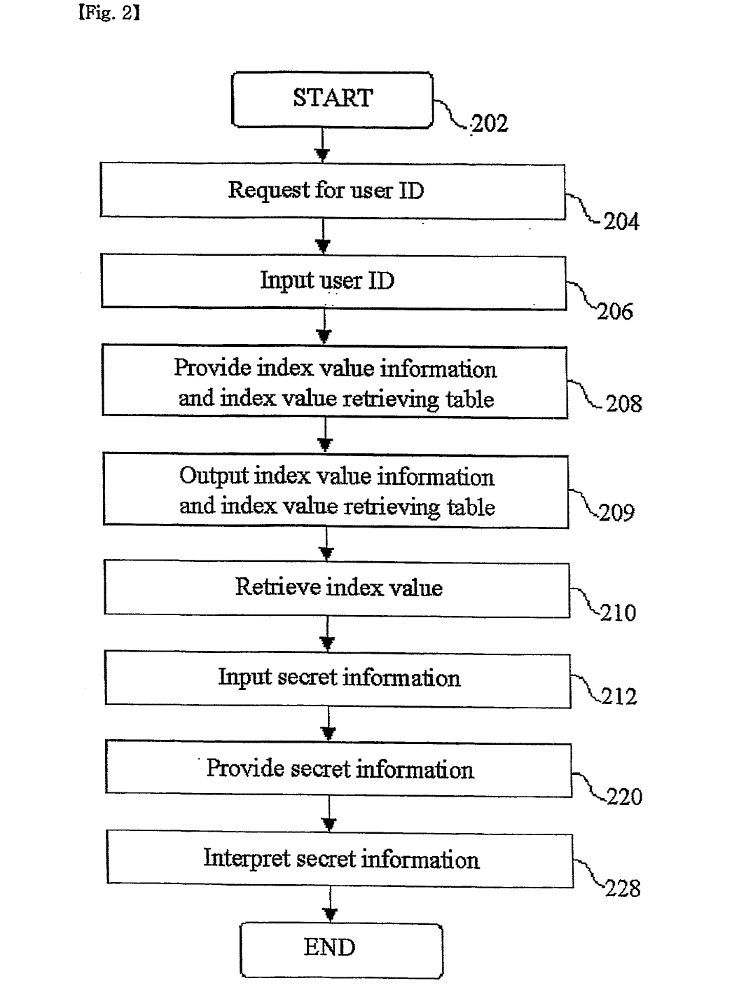

FIG. 2 is a flow chart of an embodiment of a secret information inputting method according to the present invention, where the user uses a client system for remotely connecting a server system. In this section of the specification, the idea of the present invention is described in view of the first embodiment. However, it should be noted that the present invention is not limited to the first embodiment and can be applicable to the second embodiment. Further, it is premised that the desired secret characters are composed of four (4) figures, i.e. “4567”.

The process for inputting secret information to the server system 130 at a remote place is as follows:

The user-side terminal device 110 is connected to the server system 130 through the network 120 from a remote place (step 202).

The secret information requesting unit 136 of the server system 130 requests the user-side terminal device 110 to input user identification (“user ID”) (step 204). The user inputs his/her own user ID through the input unit 111 of the user-side terminal device 110 (step 206). The steps of 202, 204 and 206 may be omitted after the process of so-called “user authentication”.

Then, the secret information requesting unit 136 of the server system 130 requests the user-side terminal device 110 to input secret information. At this step, the identifier reference table is also provided to the user (step 208). As for examples of the method for providing the identifier reference table, it may be possible to directly display the identifier reference table on the screen of the user-side terminal device 110 or to use a separate communication unit. The provided identifier reference table may be stored on the storage unit 115.

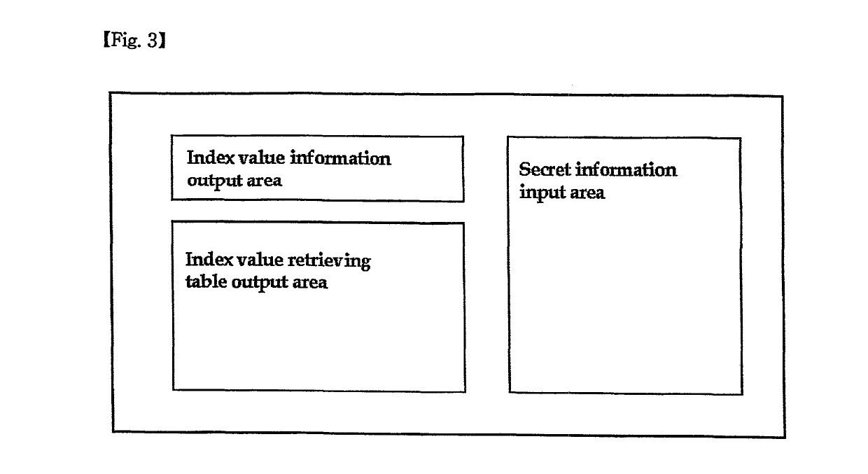

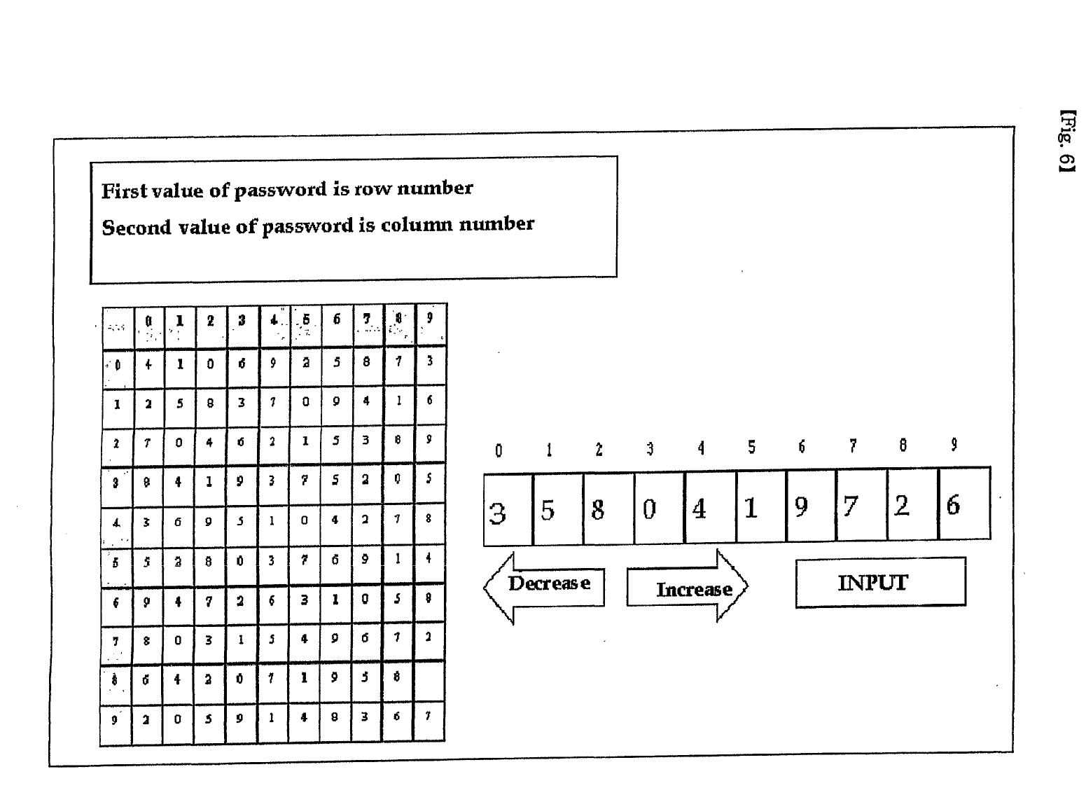

The user-side terminal device 110 displays a plurality of character values and identification signs for identifying the character values on the display unit of the output unit 112. For example, an input window, as shown in FIG. 3, may be displayed on the screen of the display unit of the user-side terminal device 110 in order for the user to input secret information. The input window may include a help-text for explaining inputting of secret information, an information box for showing inputting status of secret information, the identifier reference table, the character areas, the character values and the identification signs. FIG. 6 shows an exemplary display of the identifier reference table, the character areas, the character values and the identification signs on the screen of the display unit.

The user recognizes a true identifier by referring to the identifier index value shown in the identifier reference table (step 210). In this embodiment, the identifier of the identifier reference table is regarded as the identification sign. Therefore, the user can recognize a true identification sign through the identifier index value (step 210). Referring to the identifier reference table shown in FIG. 6, the first and second figures, i.e. “4” and “5”, of the secret characters, “4567” are respectively used as the first and second index values, and the first and second index values respectively designate the row and column of the table, which in turn specify one identifier located at a position defined by the designated row and column. For example, in case the secret character is “4567”, the fourth row and fifth column are designated by the first and second figures, or “4” and “5”, of the secret characters, and, in turn, the identifier located at the crossing position of the fourth row and fifth column, i.e. “3” in the table shown in FIG. 6, is regarded as the true identification sign.

Then, the user inputs a secret character by using the selected identification sign (step 212). The process for inputting secret characters according to the present invention, is described in detail.

First, the user determines whether or not the character value corresponding to the character area designated by the selected identification sign is identical to the desired secret character. In this specific exemplary embodiment of the present invention where the selected identification sign is “3” and the desired secret characters are “4567”, the character value corresponding to the character area designated by the identification sign “3” is “zero (0)” and the first desired secret character is “four (4)”.

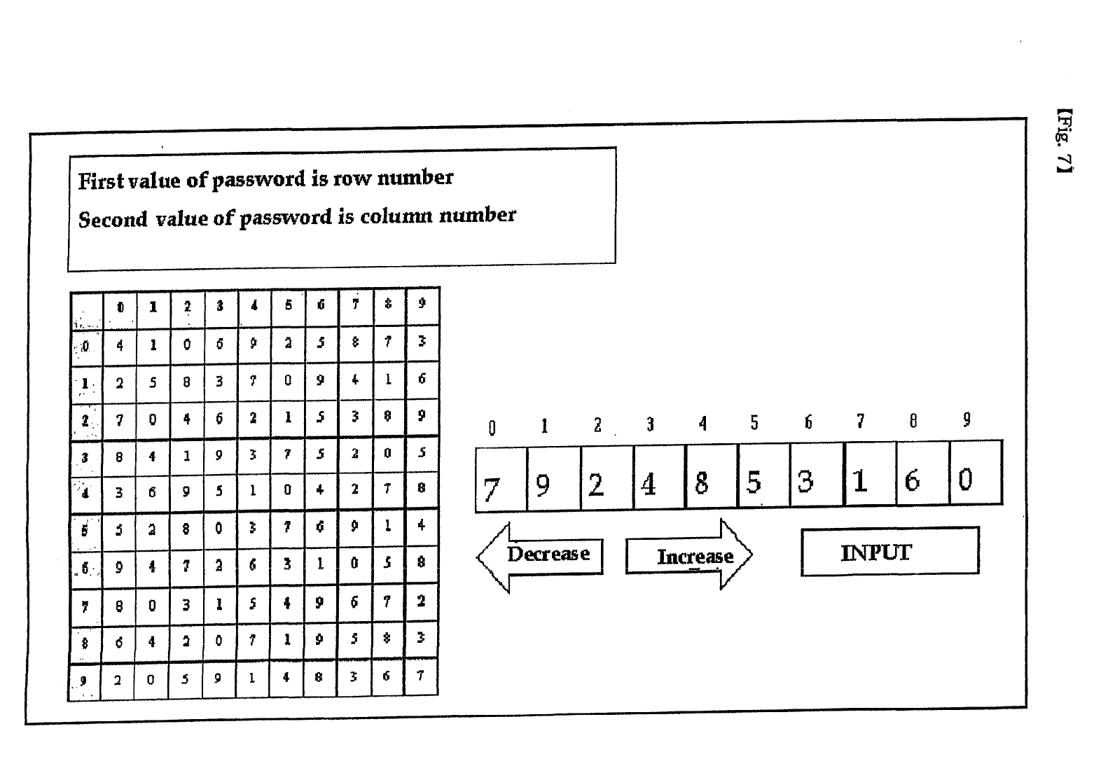

As above, in case the character value corresponding to the character area designated by the selected identification sign is not identical to the desired secret character, the user generates the first event for changing character values designated by the identification signs. In the case shown in FIG. 6, since the character value designated by the selected identification sign “3” is zero (0) and the desired first secret character is four (4), the character values designated by the identification sign “3” needs to be increased by four (4). Thus, in this example, the user may press the up-arrow key of the keyboard four times or click a mouse button when the pointer is on the “Increase” display area. The user-side terminal device 110 increases the character values displayed on the character areas in response to the detection of the generated event. FIG. 7 shows a secret information input window after the character values are increased.

Next, after the character value designated by the selected identification sign, “3”, is identical to the first secret character, “4”, the user generates the second event for storing the character value. According to this embodiment, the user may press the “Enter” key or click a mouse button when the pointer is on the “Input” display area of the screen.

As described above, according to the present invention, since only the user knows the selected identification sign and all of the character values including the one designated by the selected identification sign are increased, the used computer itself as well as a third person watching the screen can not recognize which character is selected.

Then, the information processing unit 113 of the user-side terminal device 110 stores information on the whole character values designated by the identification signs, and the process for inputting a secret character composing secret information (step 216). As described above, information on character values may include the character values themselves and change history of character values, character areas and/or identification signs. According to the present invention, it is more preferable to store information on the whole character values displayed on the screen than to store information on a specific character value. However, in some cases like when the information on the character value is the change history of the character values, character areas or the identification signs, the change history may be common to all character values. In this case, only the change history, which is common to all character values, may be stored.

The above steps for inputting a secret character are repeatedly performed until all of the desired secret characters composing secret information are completely inputted (step 218).

The information processing unit 113 provides to the server system 130 the information on the character values corresponding to the secret characters composing secret information (step 220), where the information on the character values are generated by performing the step 218, as described above.

The server system 130 retrieves identification signs corresponding to the index values of the identification signs for the secret characters of the secret information provided when the server requests inputting of secret information.

The secret information interpreting unit 137 extracts one of the secret characters composing secret information by extracting a character value corresponding to the retrieved identification sign out of the character values stored in regard to the first secret character of the secret characters provided at the step 220.

The above step for extracting one secret character is repeatedly performed until all of the inputted secret characters of secret information are extracted.

The secret information inputted by the user can be recognized by performing the above described steps (step 228).

According to the present embodiment, identification signs are selected and character values designated by the selected identification signs are changed to input secret information. However, it is clear that the present invention is not limited to this embodiment. For example, it is possible to embody the present invention without performing the step of selecting the identification signs. In this case, the user may decide identification signs used for inputting secret information at his/her own discretion and input the secret information by using character values designated by the determined identification signs.

Further, the present invention can also be applicable to the case where the user determines identification signs used for inputting secret information at his/her own discretion, inputs secret information by using the determined identification sings and provides information on selected identification information to the secret information interpreting system. In this case, only the user knows identification signs used for inputting secret information, and the secret information interpreting system can interpret the secret information by using the identification signs provided from the user.

Stand-alone System

The secret information inputting method of the present invention shown in FIG. 2 can also be applicable to a stand-alone system which is not on-line.

According to another embodiment of the present invention, a secret information inputting method is embodied on a stand-alone system which is not connected to a network. This embodiment is described in detail with reference to FIG. 1. In this stand-alone system, both the user-side terminal device 110 and the server system 130 form a single body system. The network 120 shown in FIG. 1 can be regarded as an internal bus or data line of the single body system.

Now, operation of the above described single body system is described with reference to FIG. 2.

First, the user starts the secret information inputting method on the single body system (step 202). The secret information requesting unit 136 request the user to input his/her user ID (step 204). The user inputs the user ID through the input unit 111 (step 206). The steps of 202, 204 and 206 may be omitted after the process of so-called “user authentication”.

Then, the secret information requesting unit 136 requests the user to input secret information. At this step, the identifier reference table is also provided to the user (step 208). As for examples of the method for providing the identifier reference table, it may be possible to directly display the identifier reference table on the screen of the user-side terminal device 110 or to use a separate communication unit.

The output unit 112 displays character areas, character values, identification signs and identifier reference table on the screen. Details of the input window displayed on the screen are similar to those described above for the first embodiment.

The user recognizes an identification sign by referring to index values shown in the identifier reference table (step 210). The user selects a true character area by using the identification sign recognized in the step 210. Character value corresponding to the selected character area can be coincide with a desired secret character by changing a character value of the selected character area or changing correspondence relation between the character area and identification sign (step 214). It may be preferred to change all of the character values of all of the character areas.

Then, the information processing unit 113 stores information on the whole character values designated by the identification signs to the storage unit 115, and the process for inputting a secret character composing secret information. The above steps for inputting a secret character are repeatedly performed until all of the desired secret characters composing secret information are completely inputted.

The system 130 retrieves identification signs corresponding to the identifier index values for the secret characters of the secret information provided when the server requests inputting of secret information.

The secret information interpreting unit 137 extracts one of the secret characters composing secret information by extracting a character value corresponding to the retrieved identification sign out of the character values stored in regard to the first secret character of the secret characters provided from the user.

The above step for extracting one secret character is repeatedly performed until all of the inputted secret characters of secret information are extracted.

As described above, according to the stand-alone system, no information is transferred through the network 130. In response to the secret information request of the secret information requesting unit 136, the user inputs secret information through the input unit 131 following the steps described referring to in FIGS. 2 and 3. Then, the required data is stored in the data managing unit 133, and the secret information interpreting unit 137 interprets the information inputted by the user by using data stored in the data managing unit 133.

According to another embodiment of the present invention, an inputting system for inputting secret information of the user and an interpreting system for interpreting the secret information inputted by the user may be formed independently of each other to embody the present invention. This embodiment is analogous to the above described embodiment where a user-side terminal device is connected to a server system through a network, and detailed explanation is omitted. However, in this embodiment, since the inputting system is not networked with the interpreting system, the information communication between them is performed by external media, such as a diskette or a CDROM.

Examples of stand-alone system may include following applications, where; first, a user wants to install locking unit on his/her computer system; second, a user wants to install passwords on his/her computer files; and third, a user wants to save or transfer his/her message.

As described above, in various cases for inputting secret information under off-line states, the stand-alone system may be used for inputting secret information. In other words, the secret information inputting method described by referring to FIG. 2 can be used to an off-line terminal.

The present invention described above may have exemplary applications as follows:

First, the present invention may be applicable to inputting and transferring various secret information. Especially, the present invention may be used to applications where security is specifically important like transferring national secret information. Second, the present invention may be applicable to inputting account information for bank transaction or stock exchange, passwords and/or credit information. Third, the present invention may be applicable to inputting credit card information for on-line e-commerce. Fourth, the present invention may be applicable to inputting passwords for Internet content services or Internet game services. Fifth, the present invention may be applicable to transferring private secret message. Sixth, the present invention may be applicable to maintaining and acknowledging secret information. Further, the present invention may also be widely applicable to systems requiring user authentication like automated-teller machine, enter and exit control system, system or file locking device.

Various replacements, modification and variations of the above described present invention may be possible within the scope of the inventive subject matter of the present invention by an ordinary skilled person in the art, therefore the present invention is not limited to the above described embodiments of the description or attached drawings.

According to the above described present invention, since a plurality character values are displayed on a screen and secret information is inputted by the user using a true character value known only to the user while the displayed character values are changed, the secret information inputted by the user and stored in a user computer is not easily revealed and a third party watching the input process can not recognize the inputted secret information.

Further, according to the conventional technology, when an index table used for random number inputting method, which is generally used by conventional banks or a generator and a receiver for “one time password” is lost or stolen, the secret information is easily revealed and the user is damaged. According to the present invention, however, even the identifier reference table or identification sign generator is lost or stolen, the secret information is not revealed and user authentication with the lost or stolen information is impossible.

According to the present invention, secret information is not revealed even if the character values generated by the key input is intercepted or the user computer is attacked by hacking, which is a typical problem of conventional technologies.

According to the present invention, since the secret information is transformed to be stored or transferred, the secret information remains safe even if the transmission path is wiretapped.

According to the present invention, it is possible to prevent a hacker from repeatedly tracing the secret information because independent index value is used for each of the secret characters composing the secret information. Further, when the user loses the identification sign reference information, illegal input of the secret information is not possible because illegal access of a third person, who does not know the secret information, is prevented.

Above described results of the present invention can be summarized as follows:

First, it is impossible for a third person to recognized secret information being inputted even though the third person is watching the input process since the true secret information is not revealed during the input process. Therefore, it is not required to provide means for hiding the input process, for example a hiding curtain or a closed room. Further, the user needs not pay careful attention to a third person watching the input process.

Second, there is no possibility for the secret information to be revealed even though the user-side terminal device is attacked by a hacker because the user-side terminal device does not recognized the true secret information out of the inputted information. For example, it is impossible to reveal the true secret information even though the information inputted through the input device like keyboard or mouse or stored in the storage device is revealed by an illegal software infiltrated to the user computer.

Third, it is impossible to reveal the secret information by hacking the transmission path because the transferred information through a network like Internet does not include true secret information. Therefore, it is possible to reduce system cost for developing encryption solutions like PKI.

Fourth, since the identification signs for identifying the input value are irregularly generated every time the secret character is inputted, there is no methodical pattern on the identification signs. Therefore, even though fixed values like passwords or credit card numbers are repeatedly inputted, it is impossible to trace the fixed values.

What is claimed is:

1. A secret information inputting method, using an information processing system which comprises an event detecting unit for detecting an event and a display unit, comprising:
displaying at least two of character values on a screen of said display unit, where each of said at least two of character values can be identified from each other;
displaying multiple pointers on said screen of said display unit, where said multiple pointers comprise at least two of pointers, each of which can be identified from the other;
moving at least two of pointers out of said multiple pointers on said screen of said display unit in response to a first event detected by said event detecting unit; and
recording information on said multiple pointers in response to a second event detected by said event detecting unit.

2. The method of claim 1, wherein said at least two of pointers are respectively identified by at least two of identification signs, each of which can be identified from another one(s).

3. The method of claim 1, wherein said at least two of pointers are formed to be substantially identical in appearance, and each of said at least two of pointers is identified from each other by its display location on said screen of said display unit at a predetermined point of time.

4. The method of claim 1, wherein said recording information on said multiple pointers is performed by recording information on a display location of at least one of said multiple pointers on said screen of said display unit.

5. The method of claim 1, wherein said recording information on said multiple pointers is performed by recording information on a character value designated by at least one of said multiple pointers on said screen of said display unit.

6. The method of claim 1, further comprising displaying a reference table for designating at least one of said at least two of pointers.

7. The method of claim 2 further comprising displaying a reference table for designating at least one of said at least two of identification signs.

8. The method of claim 1, further comprising transferring a reference table for designating at least one of said at least two of pointers through a separate communication means.

9. The method of claim 2 further comprising transferring a reference table for designating at least one of said at least two of identification signs through a separate communication means.

10. The method of claim 6, wherein said reference table comprises at least two of identifiers for identifying said at least two of pointers and at least two of index values for referring to said identifiers.

11. The method of claim 8, wherein said reference table comprises at least two of identifiers for identifying said at least two of pointers and at least two of index values for referring to said identifiers.

12. The method of claim 7, wherein said reference table comprises at least two of identifiers for identifying said at least two of identification signs and at least two of index values for referring to said identifiers.

13. The method of claim 1, further comprising retrieving a character value designated by a predetermined pointer of said multiple pointers when said information on said multiple pointers is recorded.

14. The method of claim 1, wherein said event detecting unit comprises a first and second input keys; wherein said first event is an operation of receiving a key input from said first input key; and wherein said second event is an operation of receiving a key input from said second input key.

15. The method of claim 1, wherein said event detecting unit comprises a displacement detecting unit for detecting a displacement of a predetermined object and an input key; wherein said first event is an operation of said displacement detecting unit detecting a displacement of said predetermined object; and wherein said second event is an operation of receiving a key input from said input key.

16. A secret information inputting method, using an information processing system which comprises an event detecting unit for detecting an event and a display unit, comprising:
displaying at least two of character values on a screen of said display unit, where each of said at least two of character values can be identified from the other;
changing at least one of character values out of said at least two of character values in response to a first event detected by said event detecting unit; and
recording information on said character value(s) in response to a second event detected by said event detecting unit.

17. The method of claim 16, further comprising setting at least two of character areas on said screen of said display unit before said displaying at least two of character values, wherein said at least two of character areas can be identified from another one(s), and wherein said displaying at least two of character values is performed by displaying said at least two of character values on said at least two of character areas, respectively.

18. A secret information inputting device comprising:
an event detecting unit for detecting an event;
a display unit;
a means for displaying at least two of character values on a screen of said display unit, where each of said at least two of character values can be identified from each other;
a means for displaying multiple pointers on said screen of said display unit, where said multiple pointers comprise at least two of pointers, each of which can be identified from each other;
a means for moving at least two of pointers out of said multiple pointers on said screen of said display unit in response to a first event detected by said event detecting unit; and
a means for recording information on said multiple pointers in response to a second event detected by said event detecting unit.

19. The device of claim 18, wherein said at least two of pointers are respectively identified by at least two of identification signs, each of which can be identified from each other.

20. The device of claim 18, wherein said at least two of pointers are formed to be substantially identical in appearance, and each of said at least two of pointers is identified from each other by its display location on said screen of said display unit at a predetermined point of time.
